(19) United States
(12) Patent Application Publication
(10) Pub. No.: US 2026/0309270 A1
(43) Pub. Date: Oct. 8, 2026

(54) UNIVERSAL MOUNTING PLATE

(71) Applicant: Flexible OR Solutions LLC, Dripping Springs, TX (US)

(72) Inventor: Scott Hodsden, Dripping Springs, TX (US)

(21) Appl. No.: 19/441,042

(22) Filed: Jan. 6, 2026

Related U.S. Application Data
(60) Provisional application No. 63/771,895, filed on Mar. 14, 2025.

(51) Int. Cl. F16M 13/02

(52) U.S. Cl. CPC F16M 13/027

(57) ABSTRACT

A universal operating room ceiling mounting plate for flexibly installing operating room equipment from the ceiling of a clinical facility having a base plate having a center aperture, slots disposed evenly along a first end and a second end of the base plate, hole clusters disposed evenly around the center aperture, and center mounting holes surrounding the center aperture, each center mounting hole flanked by at least two outer holes, with the holes threaded for adjustable connection to an operating room ceiling structure and to a suspended operating room equipment interface plate.

### PRIORITY

The present application claims priority to U.S. 63/771,895 filed Mar. 14, 2025, the entirety of which is hereby incorporated by reference.

### TECHNICAL FIELD

This disclosure relates to a clinical environment accessory and specifically to a universal mounting plate that serves as an interface for mounting operating room and clinical space medical equipment from a variety of manufacturing sources.

Traditionally, when a hospital or outpatient surgical facility wishes to improve, relocate or add surgical room equipment that is ceiling mounted or interfaced with equipment located in the interstitial space of the operating room, the operating room must be closed for extended periods of time while the new equipment is placed or the improvement is executed.

A universal, flexible operating room ceiling system solution installed during operating room facility construction is described in U.S. Pat. No. 11,408,170 issued to Applicant. The operating room ceiling system so described does not interfere with or prohibit utilization of the operating room and at the same time can accommodate virtually any surgical equipment configuration, future changes to the type and location of the surgical equipment, as well as building infrastructure requirements.

### SUMMARY

Components of an operating room including structural components, medical gas lines, electrical and data lines and heating, ventilation and cooling equipment are moveable in operating rooms in which a universal operating room ceiling system is installed. Future positioning, repositioning and placement of operating room equipment and associated medical gas lines and power requirements is made possible by such a universal ceiling system. A track assembly is positioned on a pre-fabricated grid directly above the ceiling in the interstitial space. A ceiling assembly includes air diffusers and lighting fixtures. The track assembly is configured to provide access to facilitate routing of cables, medical gas lines, and electrical conduit for electrical power. Issues surface during installation when medical equipment such as booms, lighting, and other equipment that extends down into the clinical space from the ceiling is installed and moved about the space over time. This is particularly so when equipment is sourced from different manufacturers, which is often the case. Even different equipment sourced to a single manufacturer can include various types of means for connecting the equipment to the raceway, support girds above the ceiling, or intermediate installation plates. What results is the installer of the equipment in the situation of attempting to rapidly and efficiently install the equipment when the above the ceiling hardware does not easily interface with the installation plate that might accompany the equipment. What is needed is a universal mounting plate that accommodates numerous equipment types from various manufacturers to provide predictable and efficient mounting of equipment above the ceiling, for use in the operating room or other clinical environment.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 depicts side view of a track and heating, cooling and ventilation equipment supported by a grid of red-iron frame and modular steel rails in which an embodiment of the universal mounting plate is installed;

FIG. 2 depicts a perspective view of a universal mounting plate according to an embodiment;

FIG. 3 depicts a perspective view of a universal mounting plate installed in a ceiling assembly according to an embodiment.

### DETAILED DESCRIPTION

In the following detailed description of exemplary embodiments of the invention, specific exemplary embodiments in which the invention may be practiced are described in sufficient detail to enable those skilled in the art to practice the invention, and it is to be understood that other embodiments may be utilized and that architectural, mechanical, electrical and other changes may be made without departing from the spirit or scope of the present invention. The following detailed description is, therefore, not to be taken in a limiting sense, and the scope of the present invention is defined only by the appended claims and their equivalents.

A rectangular track assembly, or raceway, made of a variety of materials including plastic and sheet metal is positioned above the ceiling vertically between ceiling level air diffusers and light fixtures and HVAC duct work. The track assembly is a rectangular or tubular trough that houses medical gases needed in the operating room as well as electrical and data lines. The track assembly is often comprised of various sections in one embodiment, including at least one removable or closeable access panel on the bottom of the track that is substantially parallel to the ceiling below. Some track assembly designs include openings at various intervals allowing access to medical gas lines and electrical and data lines contained therein. Components enter a desired area in the track assembly and are then distributed to where ceiling mounted equipment is to be located. In one or more embodiments, the ceiling mounted equipment is mechanically coupled to a structural support by an intermediate structure that receives a portion of the track assembly and includes an equipment mounting plate. The track assembly allows medical gas lines, electrical cables, and communication cables to be readily rerouted if the ceiling mounted equipment is moved or upgraded or additional ceiling mounted equipment is added.

With the track assembly and complete structural support positioned above the ceiling, equipment can be placed anywhere in the area within the ceiling system frame and grid. If new equipment is required to be installed, the location of the new equipment is not limited by the placement of the old equipment and can be located anywhere within the frame and grid. The footprint of the track assembly and structural support covers the operating area within the operating room, which is typically the center of the room, and can extend outward from the room's center. The lighting installed in the universal frame and grid provides ample lighting of the patient area, access to ceiling mounted equipment, and one or more light fixtures can be readily removed to provide access to the track assembly. In addition, the air diffuser provides a clean patient area.

Optionally, the ceiling assembly can include air diffusers used to circulate clean air over an operating table. For example, the air diffuser assembly can include a plurality of high-efficiency particle absorption (HEPA) filtered air vents or non-HEPA filtered air vents.

A support structure integrated above the ceiling is configured to support the operating room ceiling system and ceiling mounted surgical equipment (anesthesia booms, surgical lights, etc.) via modular steel rails, such as Hilti brand rails. In various embodiments, surgical equipment may be positioned anywhere within the ceiling frame and grid system. According to various aspects of the present disclosure, additional surgical equipment can be added with little to no structural support cost by simply making medical gas lines and electrical and data cabling available through the track assembly and structurally attaching the added equipment to the modular steel rails. The presently described ceiling system can be readily re-configured as needed. For example, removable bottom panels of the track assembly can be relocated to another location on the track assembly (or replaced with new panels) when various equipment requires relocation.

In various embodiments, communication cables are pulled into the track assembly and routed to specific equipment. In one or more embodiments, medical gas is hard piped to a top wall of the track assembly and a hose inside the track assembly is employed to deliver the gas to a desired location. Similarly, power is provided inside the track assembly and conduit (rigid or flexible) and junction-boxes can be employed to distribute power throughout the track assembly.

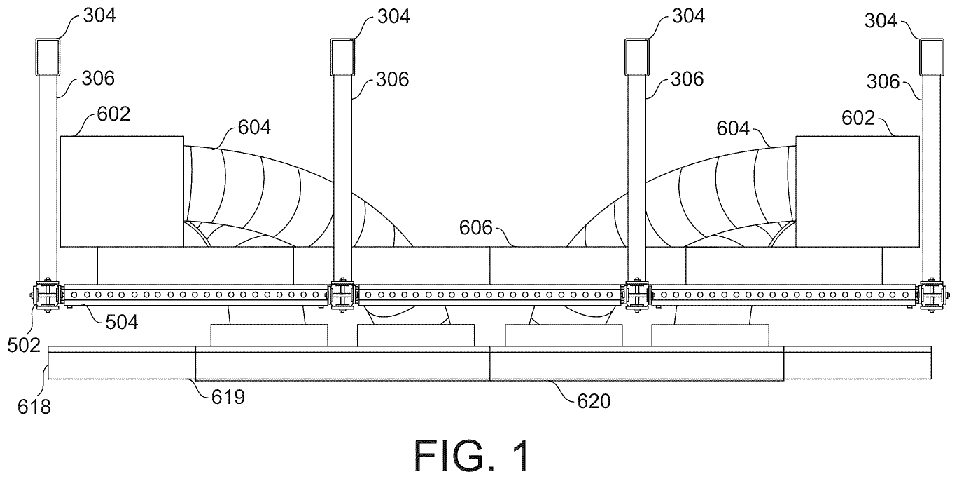

The track assembly can be used to distribute medical gas lines, power cables, and/or communication cables to various ceiling mounted surgical equipment, as well as any other devices that are incorporated into the track assembly. In one or more embodiments, the track assembly includes several sheet metal or plastic track boxes FIG. 1 provides a side view of an operating room ceiling system in which an embodiment of the presently described universal mounting plate is installed. FIG. 1 provides a side view of a partially assembled operating room ceiling system according. As shown in FIG. 1, the red iron frame and grid arrangement comprising the modular steel rails 502 connected to red iron frame support members 306 serves as the support structure for medical equipment, HVAC duct work, diffusers and a track assembly for housing medical gas lines and electrical and data lines and provides structural support for medical equipment. Track assembly 606 is arranged directly above modular steel rails 502 that are placed as a grid. Track assembly 606 can be rectangular and tubular in shape and provided in sections for ease of installation and assembly. In some systems, track assembly 606 is arranged as a rectangle extending close to the perimeter of the grid formed by modular steel rails 502.

Also shown in FIG. 1 are HVAC trunk lines 602 installed above track assembly 606. Trunk lines 602 includes multiple ports to which HVAC ducts 604 are connected to provide adequate air circulation to the operating room. A lower end of each HVAC duct 604 is connected to ceiling assembly 618 having at least one diffuser 620 through which recirculated and filtered air is returned to the operating room. Ceiling assembly 618 and diffuser 620 in one embodiment is flush with the interior ceiling of the operating room. Ducts 604 as will be discussed reside within the interior of the rectangle formed by track assembly 606 in order to avoid interference with operating room equipment connection to medical gas lines and electrical and data cables both during new construction and later repositioning or adding or removal of equipment. That is, the duct ports preinstalled in trunk line 602 face the interior of the grid formed by the modular steel rails 502. The corresponding HVAC ducts 604 will connect to air diffusers located within the perimeter of track assembly 606.

In one embodiment, track assembly 606 supports connection of medical columns or booms through which hoses carrying medical gas, as well as electrical cables, data cables, etc. In at least one embodiment, ceiling assembly is the lowest layer of the universal ceiling system and serves as the interior ceiling of the operating room or clinical space. Ceiling assembly 618 includes one or more diffusers 620 that can be HEPA diffusers. Ceiling assembly 618 in one embodiment can also include light assembly 619. Track assembly 606 is positioned directly above the grid formed by modular steel rails 502 and 504. Above and to the outside of track assembly 606 are HVAC trunk lines 602. Below track assembly 606 is ceiling assembly 618. Ceiling assembly 618 in one embodiment comprises a number of separate panels of typical dimensions for commercial ceiling tiles. Some of these separate panels can be diffuser panels 620 and lighting panels 619. Optionally, lighting panels 619 can include a plurality of troffers, including, LED, fluorescent, or incandescent troffers.

In connection with ceiling systems such as the one described above, repositioning of operating room equipment is contemplated and made available through the flexibility offered by the track assembly. The ability to run data, electrical and medical gas lines throughout the track assembly, and access panels provided in the track assembly permit easy repositioning of equipment without construction process interruptions. The ceiling system described above is an exemplary embodiment of a ceiling configuration in a surgical, outpatient or other medical setting, but is by no means limiting. The presently described universal mounting plate accommodates structures having various configurations.

The presently described universal mounting plate works in conjunction above the ceiling system described to provide fast and effective mounting of medical equipment. In one embodiment, the presently described universal mounting plate has dimensions consistent with the manufacturer's interface plate that accompanies medical equipment typically mounted in an operating room or other clinical environment ceiling. As discussed, the ceiling structure described above is but one of limitless examples of a mounting environment in which the presently described universal mounting plate is used. The precise details and features of the structure to which the presently described universal mounting plate is installed is by no means limiting, which further underscores the universal nature of the mounting plate.

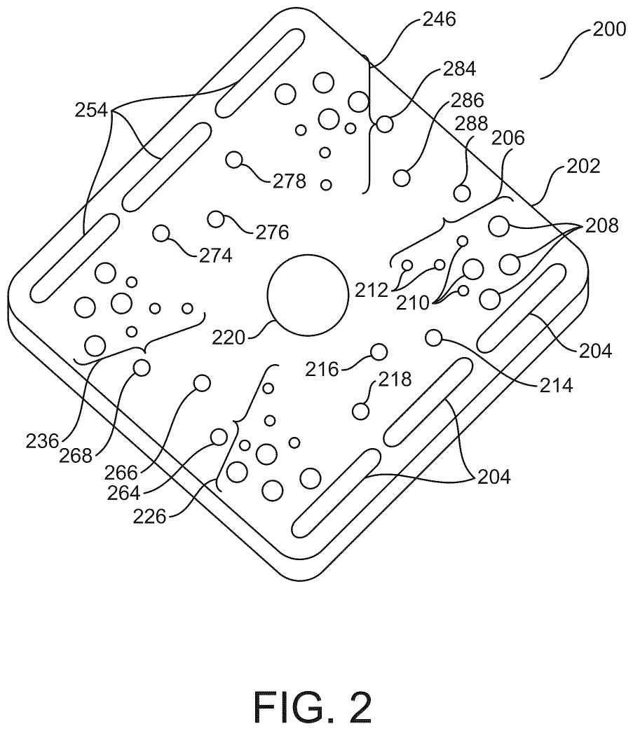

FIG. 2 depicts a perspective view of a universal mounting plate according to an embodiment for placement of the presently described universal mounting plate within an operating room ceiling assembly such as ceiling assembly 618 of FIG. 1. Note, however, that the operating room universal ceiling system and ceiling assembly 618 described is only one example of the environment in which the presently described universal mounting plate is installed. Installation of the universal mounting plate described herein is appropriate in any clinical setting in which ceiling mounting or above the ceiling mounting of equipment is desired.

In FIG. 2, universal mounting plate 200 comprises base 202 that includes a plurality of purposefully disposed slots and holes of various sizes to align with surgical equipment OEM installation interface devices. Base 202 in one embodiment is rectangularly shaped, but the present invention is not limited to this shape or thickness or base 202. Base 202 includes slot sets 204 and 254 arranged in one embodiment along opposite edges of base 202. As shown, slot sets 204 and 254 are evenly sized and in a group of three slots. More or fewer slots and/or holes are disposed on the base depending on the application. Slots sets 204 and 254 serve to provide an adjustable means for fastening base 202 to steel support structures above the ceiling, such as girders 502 or iron support members 306 with multiple fasteners, which include but are not limited to nut and bolt pairs and other suitable fasteners.

Arranged at each corner of base 202 are hole clusters 206, 226, 236 and 246. In one embodiment, each hole cluster includes exterior holes row 208 (for hole cluster 206), intermediate holes row 210 (for hole cluster 206) and lower holes column 212 (for hole cluster 206). Each hole cluster includes the same arrangement of hole rows and a column. In an embodiment, holes of exterior holes row 208 are of a diameter larger than the diameter of the holes of intermediate holes row 210 and lower holes column 212. Between hole clusters are first center mounting hole 216 (between mounting hole clusters 206 and 226), second center mounting hole 266 (between mounting hole clusters 226 and 236), third center mounting hole 276 (between mounting hole clusters 236, and 246) and fourth center mounting hole 286 (between mounting hole clusters 246 and 206). The four center mounting hole clusters are each flanked by outer hole pairs. First outer hole 214 and second outer hole 218 flank first center mounting hole 216. Third outer hole 264 and fourth outer hole 268 flank second center mounting hole 266. Fifth outer hole 274 and sixth outer hole 278 flank third center mounting hole 276. Seventh outer hole 284 and eighth outer hole 288 flank fourth center mounting hole 286. At the center of base 202 is center opening 220. Center opening 220 allow passage of data lines, cables or other items that are to be made available at the ceiling for medical equipment. This combination of holes as described provides a high level of flexibility for mounting equipment from a ceiling or otherwise and accommodates a virtually endless number of OEM equipment mounting hole combinations.

In one embodiment, some or all of the holes in clusters 206, 226, 236 and 246, of center mounting holes 216, 266, 276 and 286, and of outer holes 214, 218, 264, 268, 274, 278, 284 and 288 are partially or fully threaded for receipt of a correspondingly threaded coupling device such as a bolt. In other embodiments, some or all of the holes in clusters 206, 226, 236 and 246, of center mounting holes 216, 266, 276 and 286, and of outer holes 214, 218, 264, 268, 274, 278, 284 and 288 are not threaded, and other types of coupling devices are employed.

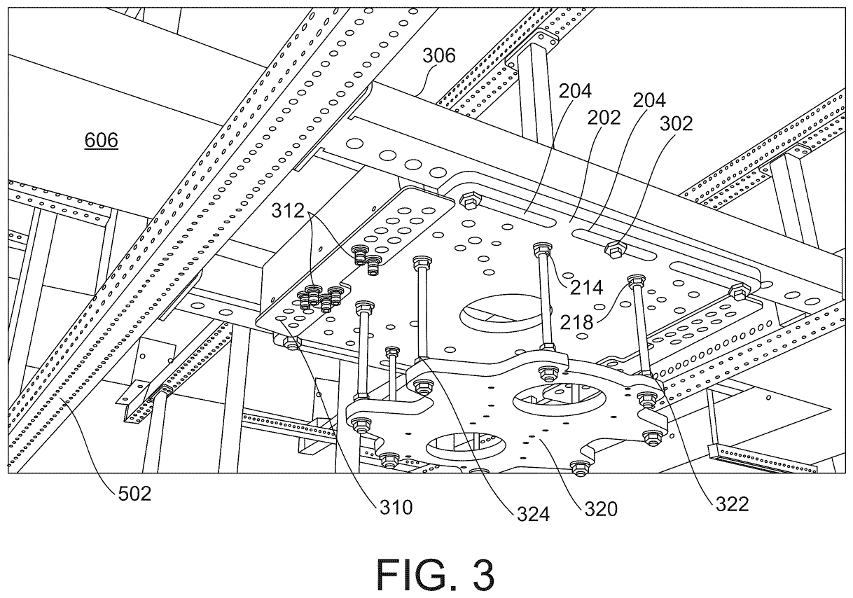

FIG. 3 depicts a perspective view of a universal mounting plate installed in ceiling assembly according to an embodiment. In FIG. 3, universal mounting plate 200 is installed within the ceiling support structure described in FIG. 1. As shown, base 202 is installed on iron frame support members 306 within an operating room ceiling system as described. As shown in FIG. 3, iron frame support members are support modular steel rails 502, although the presently described universal mounting plate is used as effectively with other commercially available or custom made structural framing members. Fastener combinations 302 (such as common nut and bolt sets or other suitable fasteners) are disposed within the several slot sets 204 within base 202 to secure base 202 to frame support members 306. As shown, multiple fastener combinations are employed and all or fewer than all slot sets 204 may be fitted with a fastener combination.

Optionally, in one embodiment raceway coupler 310 is disposed on one or two sides of installed base 202. Raceway coupler 310 extends from raceway 606 and interfaces with an access port or door of raceway 606. Medical gas lines are laid within raceway 606 to make medical gas available in the operating room. The medical gas lines within raceway 606 are passed through the raceway access port (not shown) and extend into the raceway coupler 310. Raceway coupler 310 includes one or more apertures in which medical gas line fittings 312 are installed. As shown, medical gas line fittings 312 are of the size commonly used to provide medical gas via a hose connected to the medical gas line fitting. The other end of the gas line hose is supplied to the appropriate medical device within the operating room.

Manufacturer installation plate 320 is shown connected to and beneath base 202. Manufacturer installation plate 320 is provided by the OEM of the medical equipment. The holes disposed within manufacturer installation plate 320 are so placed to accommodate the subject equipment. As shown, several bolts, including bolts 322 and 324 are disposed through mounting holes at the perimeter of manufacturer installation plate 320 and fastened to base 202 by threading bolts 322 and 324 into aligned holes within base 202. As shown, first outer hole 214, second outer hole 218, third outer hole 264, fourth outer hole 268, fifth outer hole 274, sixth outer hole 278, seventh outer hole 284 and eighth outer hole 288 (as shown in FIG. 2 and partially obscured in FIG. 3) receive bolts 322, 324 and other similar bolts through threaded engagement. The bolts are secured into place with corresponding nuts or other fastener devices may be employed. In other embodiments, other known fastening means are employed. As installed, manufacturer installation plate 320 hangs from base 202 at a desired distance below the ceiling support structure. Some or all of the unused holes of manufacturer installation plate 320 align with corresponding mounting holes or connectors on the OEM equipment for ceiling installation of the equipment. Thus, placement of universal mounting plate 200 allows ease in installation of the OEM manufacturer installation plate 320 with fast and ready connection of bolts to the strategically placed holes of base 202. Manufacturer installation plate 320, as shown, also includes its own center openings, corresponding to center opening 220 of base 202 to allow wires, power and data lines, cabling, flexible conduit and the like to pass through as required. The universal mounting plate of the present invention eliminates the need for installers to create one-off hangers for equipment mounting

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solution to problems that are described herein with regard to specific embodiments are not intended to be construed as a critical, required, or essential feature or element of any or all the claims.

### ADDITIONAL DISCLOSURE

The following clauses are offered as further description of the disclosed invention.

### Clause 1

A universal operating room ceiling mounting plate, comprising: universal mounting plate a base plate having a center aperture;
a plurality of slots disposed evenly along a first end and a second end of the base plate;
a plurality of hole clusters disposed evenly around the center aperture; each hole cluster having an exterior holes row including a plurality of exterior holes, an intermediate holes row including a plurality of intermediate holes, and a lower holes column including a plurality of lower holes; and
a plurality of center mounting holes surrounding the center aperture, each center mounting hole flanked by at least two outer holes;
wherein a fastener is adjustably installable in each of the plurality of slots for adjustably connecting the base to a support structure above the ceiling.

### Clause 2

The universal operating room ceiling mounting plate of any preceding or proceeding claim, wherein the base plate is secured by at least one raceway coupler that couples the plate to a raceway.

### Clause 3

The universal operating room ceiling mounting plate of any preceding or proceeding claim, wherein the at least one raceway coupler comprises a medical gas line fitting.

### Clause 4

The universal operating room ceiling mounting plate of any preceding or proceeding claim, wherein the at least two outer holes are threaded to receive a corresponding threaded fastener for securing a suspended operating room equipment installation interface.

### Clause 5

The universal operating room ceiling mounting plate of any preceding or proceeding claim, wherein an exterior hole diameter is larger than an intermediate hole diameter.

### Clause 6

The universal operating room ceiling mounting plate of any preceding or proceeding claim, wherein the intermediate hole diameter is larger than a lower hole diameter.

### Clause 7

The universal operating room ceiling mounting plate of any preceding or proceeding claim, wherein a lower hole diameter is larger than an intermediate hole diameter.

### Clause 8

The universal operating room ceiling mounting plate of any preceding or proceeding claim, wherein the intermediate hole diameter is larger than an exterior hole diameter.

### Clause 9

The universal operating room ceiling mounting plate of any preceding or proceeding claim, wherein each of the plurality of exterior holes, each of the plurality of intermediate holes row, and each of the plurality of lower holes are threaded to receive a threaded fastener.

### Clause 10

A universal operating room ceiling mounting system, comprising:
a base plate having a center aperture;
a plurality of slots disposed evenly along a first end and a second end of the base plate;
a plurality of hole clusters disposed evenly around the center aperture; each hole cluster having an exterior holes row including a plurality of exterior holes, an intermediate holes row including a plurality of intermediate holes, and a lower holes column including a plurality of lower holes;
a plurality of center mounting holes surrounding the center aperture, each center mounting hole flanked by at least two outer holes;
a raceway coupler that couples the base plate to a raceway; and
a plurality of threaded fasteners adjustably installable in each of the plurality of slots for adjustably connecting the base to a support structure above the ceiling.

### Clause 11

The universal operating room ceiling mounting system of any preceding or proceeding claim, further comprising a medical gas line fitting disposed in the raceway coupler.

### Clause 12

The universal operating room ceiling mounting system of any preceding or proceeding claim, wherein the at least two outer holes are threaded to receive a corresponding threaded fastener for securing a suspended operating room equipment installation interface.

### Clause 13

The universal operating room ceiling mounting system of any preceding or proceeding claim, wherein an exterior hole diameter is larger than an intermediate hole diameter.

### Clause 14

The universal operating room ceiling mounting system of any preceding or proceeding claim, wherein the intermediate hole diameter is larger than a lower hole diameter.

### Clause 15

The universal operating room ceiling mounting system of any preceding or proceeding claim, wherein a lower hole diameter is larger than an intermediate hole diameter.

### Clause 16

The universal operating room ceiling mounting system of any preceding or proceeding claim, wherein the intermediate hole diameter is larger than an exterior hole diameter.

### Clause 17

The universal operating room ceiling mounting system of any preceding or proceeding claim, wherein each of the plurality of exterior holes, each of the plurality of intermediate holes row, and each of the plurality of lower holes are threaded to receive a threaded fastener.

### Clause 18

The universal operating room ceiling mounting system of any preceding claim, wherein the center aperture receives a operating room equipment supply line from the track assembly.

What is claimed is:

1. A universal operating room ceiling mounting plate, comprising: universal mounting plate a base plate having a center aperture;
a plurality of slots disposed evenly along a first end and a second end of the base plate;
a plurality of hole clusters disposed evenly around the center aperture; each hole cluster having an exterior holes row including a plurality of exterior holes, an intermediate holes row including a plurality of intermediate holes, and a lower holes column including a plurality of lower holes; and
a plurality of center mounting holes surrounding the center aperture, each center mounting hole flanked by at least two outer holes;
wherein a fastener is adjustably installable in each of the plurality of slots for adjustably connecting the base to a support structure above the ceiling.

2. The universal operating room ceiling mounting plate of claim 1, wherein the base plate is secured by at least one raceway coupler that couples the plate to a raceway.

3. The universal operating room ceiling mounting plate of claim 2, wherein the at least one raceway coupler comprises a medical gas line fitting.

4. The universal operating room ceiling mounting plate of claim 1, wherein the at least two outer holes are threaded to receive a corresponding threaded fastener for securing a suspended operating room equipment installation interface.

5. The universal operating room ceiling mounting plate of claim 1, wherein an exterior hole diameter is larger than an intermediate hole diameter.

6. The universal operating room ceiling mounting plate of claim 5, wherein the intermediate hole diameter is larger than a lower hole diameter.

7. The universal operating room ceiling mounting plate of claim 1, wherein a lower hole diameter is larger than an intermediate hole diameter.

8. The universal operating room ceiling mounting plate of claim 7, wherein the intermediate hole diameter is larger than an exterior hole diameter.

9. The universal operating room ceiling mounting plate of claim 1, wherein each of the plurality of exterior holes, each of the plurality of intermediate holes row, and each of the plurality of lower holes are threaded to receive a threaded fastener.

10. A universal operating room ceiling mounting system, comprising:
a base plate having a center aperture;
a plurality of slots disposed evenly along a first end and a second end of the base plate;
a plurality of hole clusters disposed evenly around the center aperture; each hole cluster having an exterior holes row including a plurality of exterior holes, an intermediate holes row including a plurality of intermediate holes, and a lower holes column including a plurality of lower holes;
a plurality of center mounting holes surrounding the center aperture, each center mounting hole flanked by at least two outer holes;
a raceway coupler that couples the base plate to a raceway; and
a plurality of threaded fasteners adjustably installable in each of the plurality of slots for adjustably connecting the base to a support structure above the ceiling.

11. The universal operating room ceiling mounting system of claim 10, further comprising a medical gas line fitting disposed in the raceway coupler.

12. The universal operating room ceiling mounting system of claim 10, wherein the at least two outer holes are threaded to receive a corresponding threaded fastener for securing a suspended operating room equipment installation interface.

13. The universal operating room ceiling mounting system of claim 10, wherein an exterior hole diameter is larger than an intermediate hole diameter.

14. The universal operating room ceiling mounting system of claim 13, wherein the intermediate hole diameter is larger than a lower hole diameter.

15. The universal operating room ceiling mounting system of claim 10, wherein a lower hole diameter is larger than an intermediate hole diameter.

16. The universal operating room ceiling mounting system of claim 15, wherein the intermediate hole diameter is larger than an exterior hole diameter.

17. The universal operating room ceiling mounting system of claim 10, wherein each of the plurality of exterior holes, each of the plurality of intermediate holes row, and each of the plurality of lower holes are threaded to receive a threaded fastener.

18. The universal operating room ceiling mounting system of claim 10, wherein the center aperture receives a operating room equipment supply line from the track assembly.
